(19) United States
(12) Patent Application Publication
(10) Pub. No.: US 2025/0132839 A1
(43) Pub. Date: Apr. 24, 2025

(54) Device and Method for Compensating for Phase Noise

(71) Applicant: Infinera Corporation, San Jose, CA (US)

(72) Inventors: Mohamed Osman, Ottawa (CA); Essam Berikaa, Ottawa (CA); Han Sun, Ottawa (CA)

(21) Appl. No.: 18/917,763

(22) Filed: Oct. 16, 2024

Related U.S. Application Data
(60) Provisional application No. 63/544,354, filed on Oct. 16, 2023.

(51) Int. Cl. H04B 10/61

(52) U.S. Cl. CPC H04B 10/6165

(57) ABSTRACT

A signal processor and corresponding method compensate for phase noise in a received digital signal. The signal processor comprises a first stage of a phase noise compensator that computes a phase delay of the received digital signal and generates a partially phase-noise-compensated digital signal by applying to the received digital signal the phase delay computed. The signal processor further comprises a second stage of the phase noise compensator coupled to the first stage. The second stage computes a set of components of the partially phase-noise-compensated digital signal, determines, on a per-component basis, a respective phase distortion for components of the set of components computed, computes a set of corrected components by applying, on the per component basis, the respective phase distortion determined, and generates a further phase-noise-compensated digital signal based on the set of corrected components computed. Compensating for phase noise may improve the efficiency and accuracy of communication systems.

### RELATED APPLICATION

This application claims the benefit of U.S. Provisional Application No. 63/544,354, filed on Oct. 16, 2023. The entire teachings of the above application are incorporated herein by reference.

### BACKGROUND

Phase noise is a source of interference in communication systems, e.g., optical communications systems, wireless communications systems, or other communications systems for non-limiting examples. Phase noise may arise from a number of sources. For example, phase noise in an optical communications system may be sourced by a transmitter, receiver, optical fiber, or other element of the optical communications system for non-limiting examples. A presence of phase noise degrades a signal, complicating accurate recovery of information transmitted from the transmitter to the receiver.

### SUMMARY

According to an example embodiment, a signal processor is configured to compensate for phase noise in a received digital signal. The signal processor comprises a first stage of a phase noise compensator configured to compute a phase delay of the received digital signal and generate a partially phase-noise-compensated digital signal by applying to the received digital signal the phase delay computed. The signal processor further comprises a second stage of the phase noise compensator, The second stage is configured to (i) compute a set of components of the partially phase-noise-compensated digital signal, (ii) determine, on a per-component basis, a respective phase distortion for components of the set of components computed, (iii) compute a set of corrected components by applying, on the per-component basis, the respective phase distortion determined, and (iv) generate a further phase-noise-compensated digital signal based on the set of corrected components computed.

The first stage may include a clock phase detector. The clock phase detector may be configured to compute the phase delay of the received digital signal.

The first stage may be further configured to derive a phase offset from the phase delay computed and to generate the partially phase-noise-compensated digital signal by applying the phase offset derived to the received digital signal.

The first stage may include a clock phase interpolator. The clock phase interpolator may be configured to generate the partially phase-noise-compensated digital signal. The clock phase interpolator may include a filter associated with a plurality of coefficients, and the first stage may be further configured to compute a coefficient of the plurality of coefficients based on the phase delay computed.

The second stage may include a slicer. The slicer may be configured to use a modulation technique to estimate a set of symbols from the partially phase-noise-compensated digital signal generated. The slicer may be further configured to generate, based on an inverse of the modulation technique used, an additional digital signal from the set of symbols estimated. The second stage may be further configured to compute an additional set of components of the additional digital signal and to compare the set of components computed with the additional set of components computed to determine, on the per-component basis, the respective phase distortion.

The second stage may be further configured to compute the set of components using a frequency-based decomposition method and to generate the further phase-noise-compensated digital signal using an inverse of the frequency-based decomposition method.

The set of components computed may form a set of sub-bands, wherein a sub-band of the set of sub-bands includes at least one component of the set of components computed. The second stage may be further configured to determine, on a per-sub-band basis, a sub-band phase distortion based upon the phase distortion of at least one component included therein. The second stage may be further configured to compute the corrected components by applying, on the per-component basis, the phase distortion of the sub-band including the component.

The second stage may be further configured to determine, on the per-component basis, the respective phase distortion by removing modulation and amplifier noise from the partially phase-noise-compensated digital signal.

The received digital signal may be a digital representation of a continuous-time signal that has been sampled at a rate of at least one sample per symbol. The first stage may be further configured to compute the phase delay on a length of the digital signal. The length may be based on the rate.

The phase noise may be equalization enhanced phase noise. The first stage may be configured to compensate for the equalization enhanced phase noise in part and the second stage may be configured to compensate further for the equalization enhanced phase noise.

According to another example embodiment, signal processor is configured to compensate for phase noise in a received digital signal. The signal processor comprises a first path of a phase noise compensator configured to compute a phase delay of the received digital signal and generate a phase-noise-compensated digital signal by applying to the received digital signal the phase delay computed. The signal processor further comprises a second path of the phase noise compensator. The second path includes a first stage of the second path configured to compute the phase delay of the received digital signal and generate a partially phase-noise-compensated digital signal by applying to the received digital signal the phase delay computed. The second path further includes a second stage of the second path coupled to the first stage, the second stage configured to (i) compute a set of components of the partially phase-noise-compensated digital signal, (ii) determine, on a per-component basis, a respective phase distortion for components of the set of components computed, (iii) compute a set of corrected components by applying, on the per-component basis, the respective phase distortion determined, and (iv) generate a further phase-noise-compensated digital signal based on the set of corrected components computed. The signal processor is further configured to compensate for the phase noise using the first path or the second path based upon a threshold of the phase noise in the received digital signal.

According to another example embodiment, a method of compensating for phase noise in received digital signal may comprise computing a phase delay of the received digital signal, generating a partially phase-noise-compensated digital signal by applying to the received digital signal the phase delay computed, computing a set of components of the partially phase-noise-compensated digital signal, determining, on a per-component basis, a respective phase distortion for components of components of the set of components computed, computing a set of corrected components by applying, on the per-component basis, the respective phase distortion determined, and generating a further phase-noise-compensated digital signal based on the set of corrected components computed.

The method may further comprise deriving a phase offset from the phase delay computed and generating the phase-noise-compensated signal by applying the phase offset derived to the received digital signal.

Applying the phase delay computed to the received digital signal may further include computing a coefficient of a plurality of coefficients based on the phase delay computed, the plurality of coefficients associated with a filter, the filter applying the phase delay computed to the received digital signal.

The method may further comprise using a modulation technique to estimate a set of symbols from the partially phase-noise-compensated digital signal generated, generating, based on an inverse of the modulation technique, an additional digital signal from the set of symbols estimated, computing an additional set of components of the digital signal generated, and comparing the set of components computed with the additional set of components computed to determine, on the per-component basis, the respective phase distortion.

Computing the set of components may include applying a frequency-based decomposition method and generating a further phase-noise-compensated digital signal may include applying an inverse of the frequency-based decomposition method

Determining, on the per-component basis, the respective phase distortion may include removing modulation and amplifier noise from the partially phase-noise-compensated digital signal.

According to another example embodiment, a non-transitory computer-readable medium for compensating for phase noise in a received digital signal has encoded thereon a sequence of instructions which, when loaded and executed by at least one processor, causes the at least one processor to compute a phase delay of the received digital signal. The sequence of instructions further causes the at least one processor to generate a partially phase-noise-compensated digital signal by applying to the received digital signal the phase delay computed, compute a set of components of the partially phase-noise-compensated digital signal, determine, on a per-component basis, a respective phase distortion for components of components of the set of components computed, compute a set of corrected components by applying, on the per-component basis, the respective phase distortion determined. The sequence of instructions further causes the at least one processor to generate a further phase-noise-compensated digital signal based on the set of corrected components computed.

Alternative non-transitory computer-readable medium embodiments parallel those described above in connection with the example method embodiment.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a diagram of an example embodiment of an optical communication system including a signal processor configured to compensate for phase noise in a received digital signal.

FIG. 1B is a block diagram of an example embodiment of a signal processor configured to compensate for phase noise in a received digital signal.

FIG. 1C is a block diagram of another example embodiment of a signal processor configured to compensate for phase noise in a received digital signal.

FIG. 2 is a block diagram of an example embodiment of a representative transmit-and-receive, single-carrier optical signal networking system optionally within an example embodiment disclosed herein.

FIG. 3 is a block diagram of an example embodiment of a receiver system.

FIG. 4 is a block diagram of an example embodiment of a first stage of a phase noise compensator.

FIG. 5A is a block diagram of an example embodiment of a portion of a signal processor.

FIG. 5B is a block diagram of another example embodiment of a portion of a signal processor.

FIG. 6A is a plot of an example embodiment of results from a simulation of a signal-to-noise performance.

FIG. 6B is a plot of an example embodiment of results from another simulation of signal-to-noise performance.

FIGS. 7-1 and 7-2 are a block diagram of an example embodiment of a second stage of a phase noise compensator configured to compensate for phase noise on a per-component basis.

FIGS. 8-1, 8-2, and 8-3 are a block diagram of another example embodiment of a second stage of a phase noise compensator configured to compensate for phase noise on a per-component basis.

FIG. 9A is a plot of an example embodiment of results from simulations of phase component of a digital signal on a sub-band-by-sub-band basis.

FIG. 9B is a plot of the results of FIG. 9A along with a common mode phase estimate of the digital signal.

FIG. 9C is a plot of an example embodiment of phase distortion of a digital signal computed as a difference between phase components of the digital signal of FIG. 9A and the common mode phase estimate of FIG. 9B.

FIG. 10A is a plot of an example embodiment of results from a simulation of differential phase distortion with respect to a sub-band index.

FIG. 10B is a plot of an example embodiment of the results from the plot of FIG. 10A at a different point in time.

FIG. 10C is another plot of an example embodiment of the results from FIG. 10A at another point in time.

FIG. 11 is a plot of an example embodiment of results from simulations of a cumulative density function of Q penalty.

FIG. 12A is a block diagram of an example embodiment of a workflow for acquiring optimum filter coefficients for an L-tap adaptive T-spaced finite impulse response filter in simulation.

FIG. 12B is a plot of an example embodiment of results from the plot of FIG. 12A that discloses optimal filter coefficients for a 5-tap filter as a function of phase delay.

FIG. 13 is a flow diagram of an example embodiment of a method for compensating for phase noise in a received digital signal.

FIG. 14 is a plot of an example embodiment of results from simulations of phase noise jitter amplitude versus jitter frequency.

FIG. 15 is a block diagram of an example internal structure of a computer optionally within an embodiment disclosed herein.

### DETAILED DESCRIPTION

A description of example embodiments follows.

Example embodiments for compensating for phase noise in a received digital signal are disclosed herein.

Phase noise is a significant source of interference in communication systems, e.g., optical communication systems, wireless communications systems, or other communications systems for non-limiting examples. Phase noise may arise from a number of sources, including from properties of, without limitation, a transmitter, a receiver, or an optical fiber in an optical communications system. Presence of phase noise degrades a signal, complicating an accurate recovery of information transmitted from the transmitter to the receiver. Furthermore, modern coherent optical systems may include, for example, chromatic dispersion equalizers and polarization mode dispersion equalizers, within a receiver system to mitigate the effects of chromatic dispersion and polarization mode dispersion, respectively, of a received digital signal. While these equalization techniques may be useful in enabling optical communications, including in long-haul optical communication applications for non-limiting example, such techniques may further contribute toward the phase noise in a received digital signal, resulting in equalization enhanced phase noise (EEPN).

Existing techniques have been developed to address the issue of phase noise, including the use of digital signal processing techniques to improve the noise characteristics of a received digital signal. Conventional signal processors may include a feedback clock phase recovery block configured to compensate for a portion of the phase noise of the received digital signal. Embodiments of feedback clock phase recovery blocks, including phase-locked loops, may account for low-frequency phase deviations or drift, but may be limited in their capacity to remove high-frequency phase noise or phase noise jitter, due to design characteristics of the feedback clock phase recovery block, for example, loop bandwidths of phase-locked loops. Feedforward clock phase recovery may mitigate fast phase noise jitter, but still only partially mitigates the effect of EEPN.

The presence of phase noise may pose a challenge towards accurately recovering the information transmitted from a transmitter system to a receiver system. Further, in the context of coherent optical communications, higher order modulation techniques, including 16-quadrature amplitude modulation (QAM) and 64QAM for non-limiting examples, may require increasingly higher signal-to-noise ratio (SNR). As such, systems and methods that improve phase noise compensation in a received digital signal may be useful toward improving the efficiency and accuracy of a communication system.

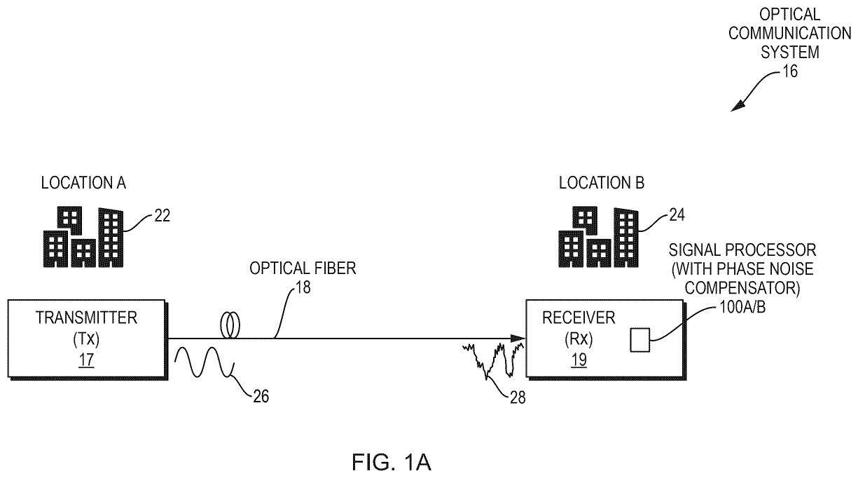

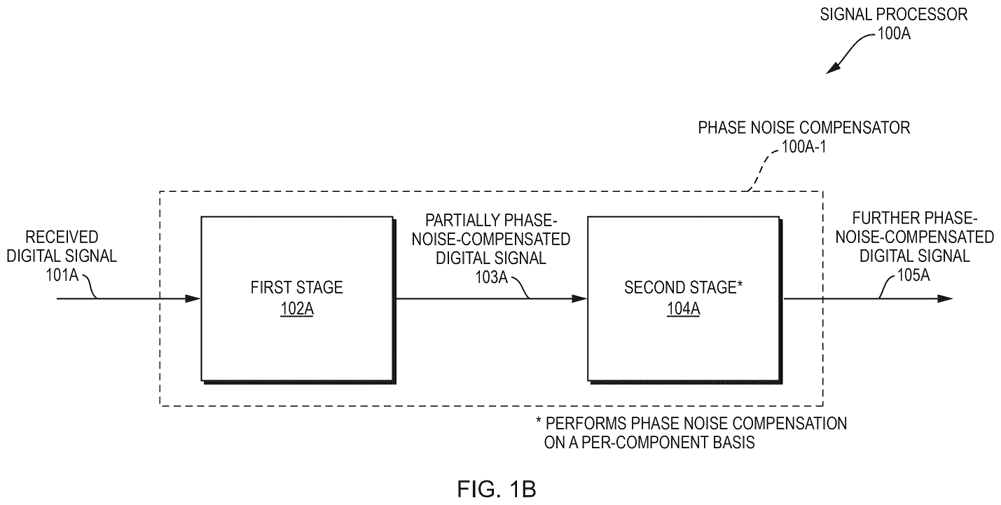

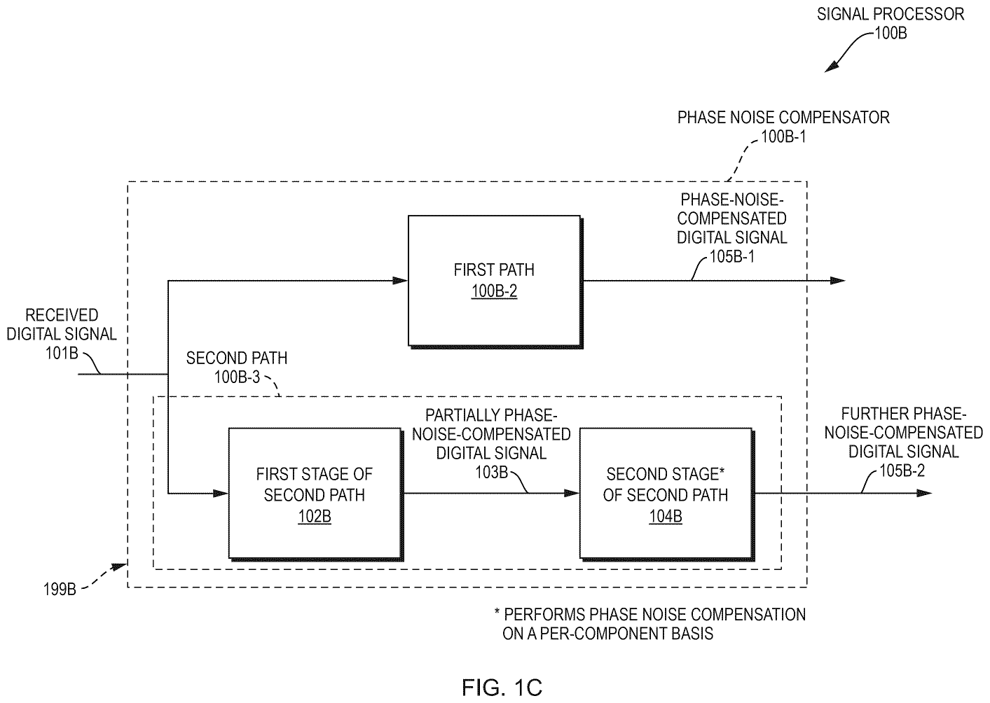

FIG. 1A is a diagram of an example embodiment of an optical communication system 16 including a signal processor 100A/B configured to compensate for phase noise in a received digital signal through use of an embodiment of a phase noise compensator, described in reference to at least FIGS. 1B and 1C and later figures. The optical communication system 16 may be configured to transmit information from a Location A 22 to a Location B 24. Location A 22 may include a transmitter 17 that transmits information along an optical fiber 18 to a receiver 19 at Location B 24. The optical fiber may transmit information across short distances or long distances. A transmitted digital signal 26 transmitted optically along the optical fiber 18 may be susceptible to sources of noise, including dispersion and jitter as non-limiting examples, resulting in a noisy digital signal 28 received by the receiver. The digital processor 100A/B in the receiver 19 may be useful for compensating for the phase noise in the noisy digital signal 28, which may be phase shifted from the original transmitted digital signal 26.

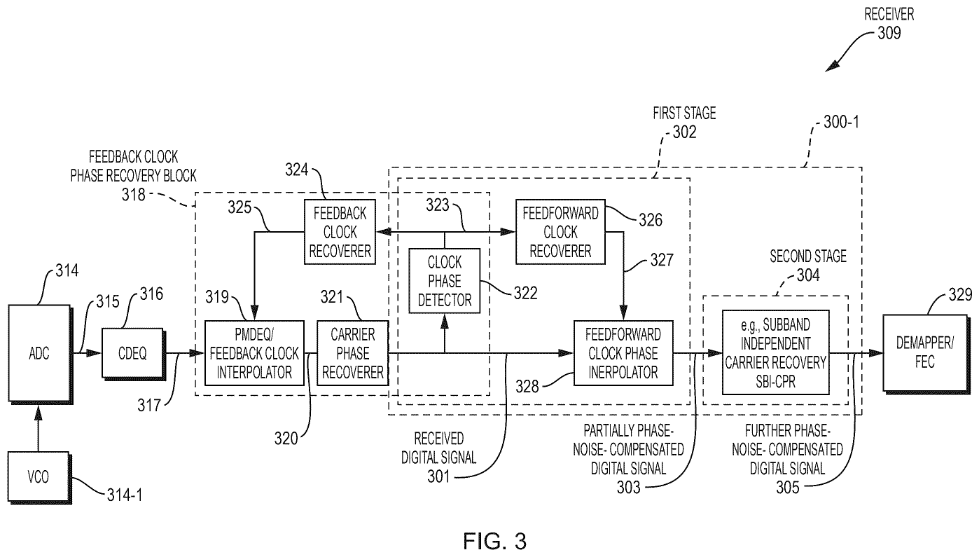

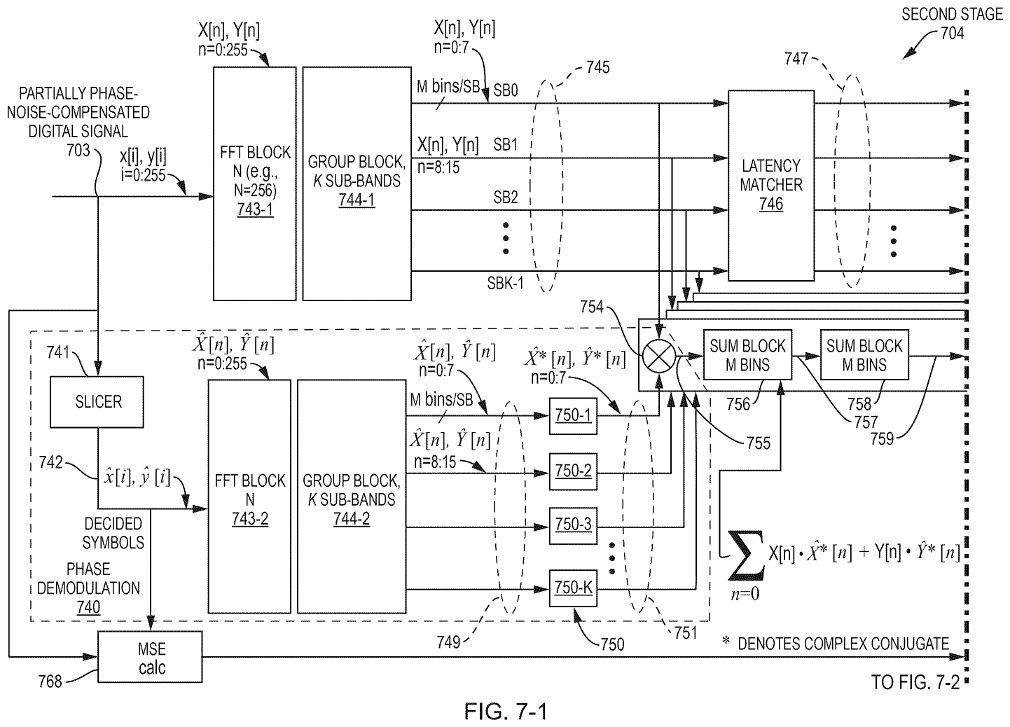

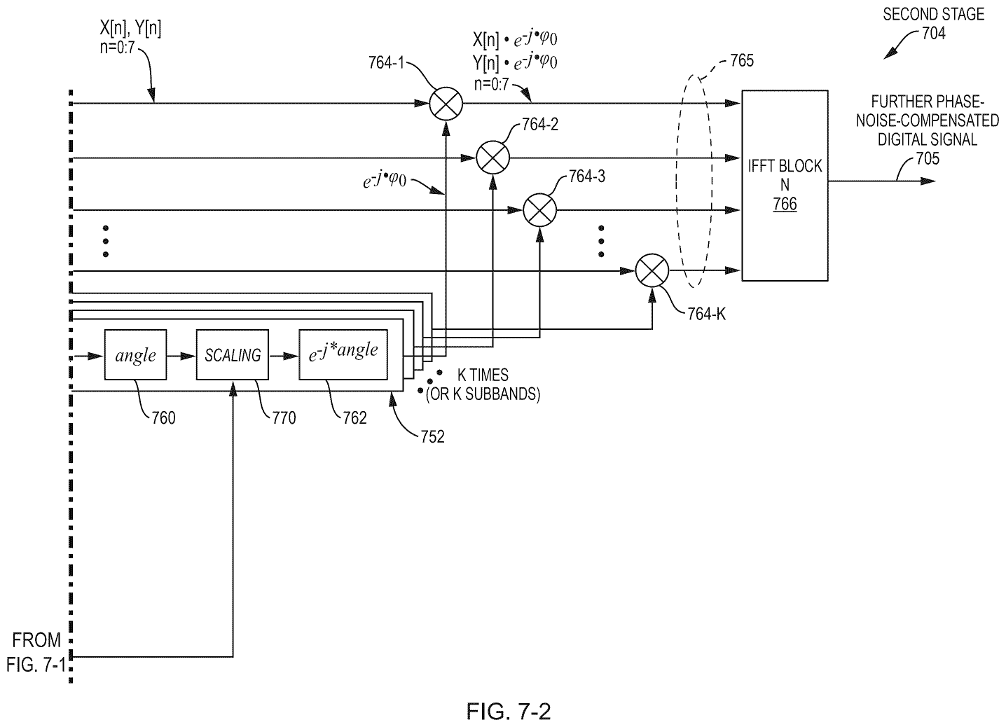

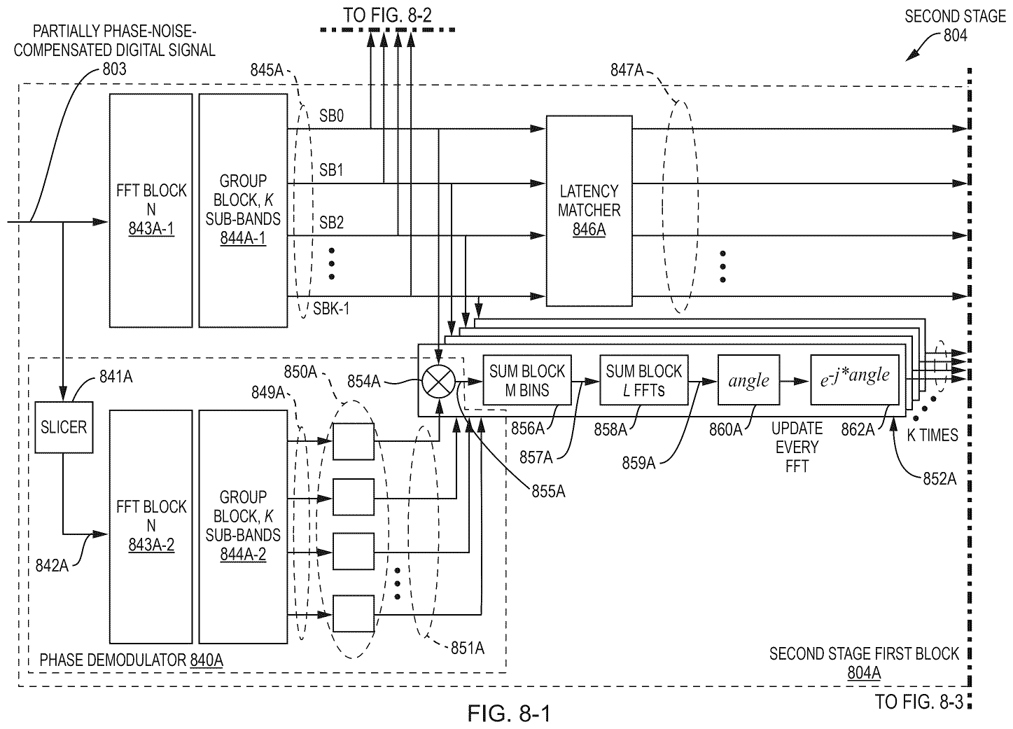

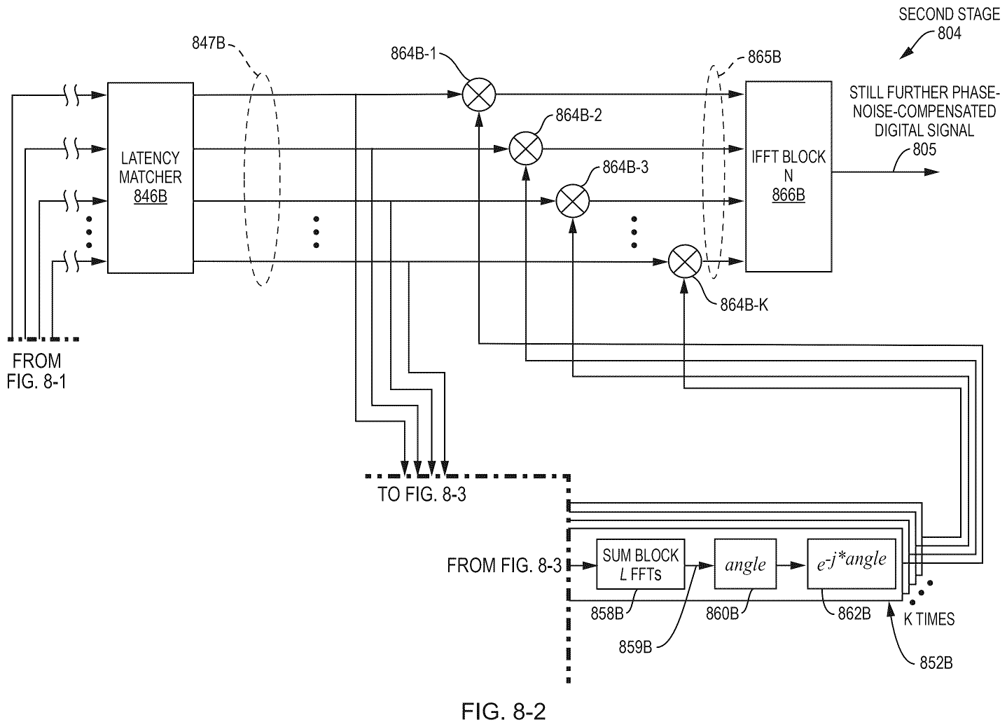

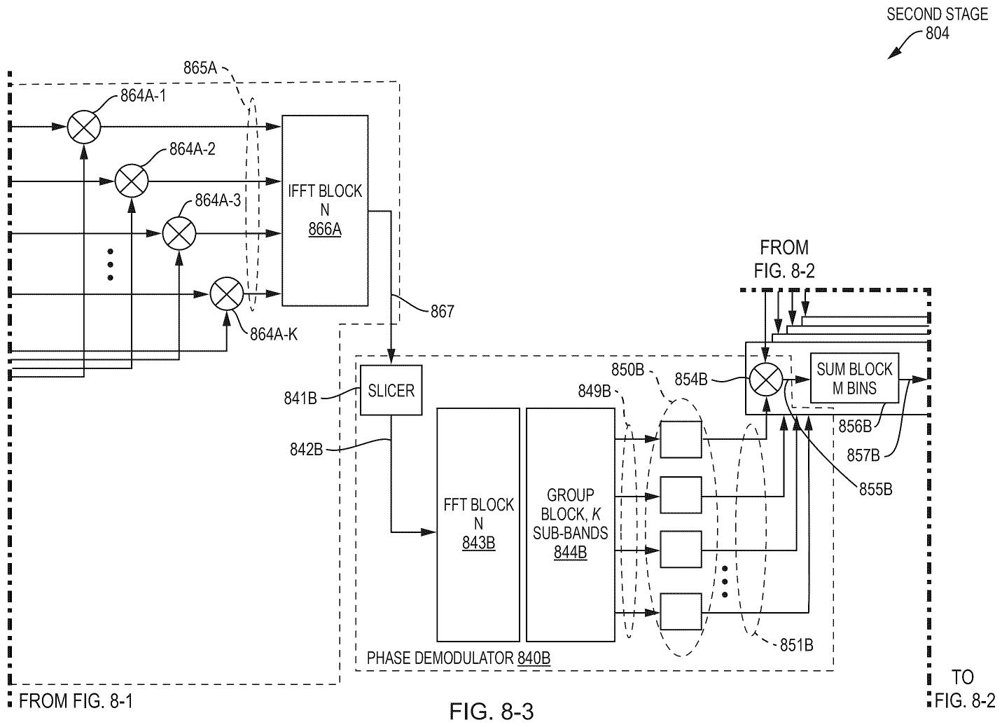

FIG. 1B is a block diagram of an example embodiment of a signal processor 100A configured to compensate for phase noise in a received digital signal 101A. The signal processor 100A may be the signal processor 100A/B in FIG. 1A. Continuing with reference to FIG. 1B, the signal processor 100A comprises a first stage 102A of a phase noise compensator 100A-1 that includes a feedforward clock recovery block (not shown) that is described in detail in reference to at least FIGS. 3-5B below and is configured to compute a phase delay of the received digital signal 101A and generate a partially phase-noise-compensated digital signal 103A by applying to the received digital signal 101A the phase delay computed. The signal processor further includes a second stage 104A coupled to the first stage 102A that generates a further phase-noise-compensated digital signal 105A from the partially phase-noise-compensated digital signal 103A. The second stage 104A of the phase noise compensator 100A-1 includes a sub-band independent phase recovery block (not shown) that is described in detail in reference to at least FIGS. 7 and 8 below and is configured to (i) compute a set of components of the partially phase-noise-compensated digital signal 103A, (ii) determine, on a per-component basis, a respective phase distortion for components of the set of components computed, (iii) compute a set of corrected components by applying, on the per-component basis, the respective phase distortion determined, and (iv) generate the further phase-noise-compensated digital signal 105A based on the set of corrected components computed.

FIG. 1C is a block diagram of another example embodiment of a signal processor configured to compensate for phase noise in a received digital signal. Signal processor 100B may be the signal processor 100A/B in FIG. 1A. Continuing with reference to FIG. 1C, the signal processor 100B comprises a first path 100B-2 of a phase noise compensator 100B-1 that includes a feedforward clock recovery block (not shown) that is described in detail in reference to at least FIGS. 3-5B below and is configured to compute a phase delay of the received digital signal 101B and generate a phase-noise-compensated digital signal 105B-1 by applying to the received digital signal 101B the phase delay computed. The signal processor further comprises a second path 100B-3 of the phase noise compensator 100B-1. The second path 100B-3 includes a first stage 102B of the second path 100B-3 that includes a feedforward clock recovery block (not shown) that is described in detail in reference to at least FIGS. 3-5B below and is configured to compute the phase delay of the received digital signal and generate a partially phase-noise-compensated digital signal 103B by applying to the received digital signal 101B the phase delay computed. The second path 100B-3 further includes a second stage 104B coupled to the first stage 102B that generates a further phase-noise-compensated digital signal 105B-2 from the partially phase-noise-compensated digital signal 103B. The second stage 104B of the second path 100B-3 includes a sub-band independent phase recovery block (not shown) that is described in detail in reference to at least FIGS. 7 and 8 below and is configured to (i) compute a set of components of the partially phase-noise-compensated digital signal 103B, (ii) determine, on a per-component basis, a respective phase distortion for components of the set of components computed, (iii) compute a set of corrected components by applying, on the per-component basis, the respective phase distortion determined, and (iv) generate a further phase-noise-compensated digital signal 105B-2 based on the set of corrected components computed. The signal processor is further configured to compensate for the phase noise using the first path or the second path based upon a threshold of the phase noise in the received digital signal. A metric 199B of the phase noise based on the threshold of the phase noise may be input to the signal processor 100B.

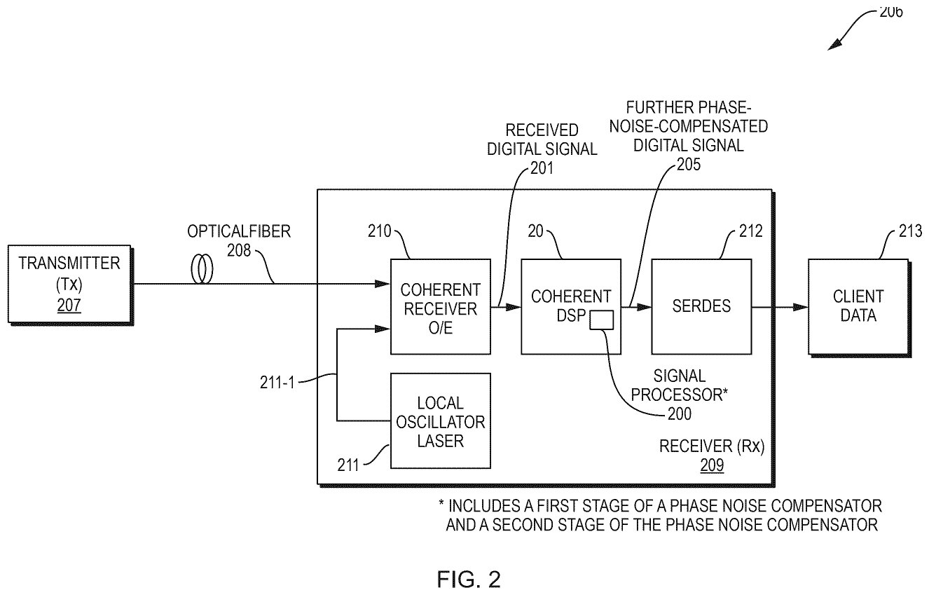

FIG. 2 is a block diagram of an example embodiment of a transmit-and-receive, single-carrier optical signal networking system 206 that may be similar to the optical communication system 16 of FIG. 1A and may include the signal processor 100A of FIG. 1B or the signal processor 100B of FIG. 1C, disclosed above, as part of a coherent digital signal processor (DSP) 200. The subject matter of FIG. 2 was disclosed in U.S. Non-provisional application Ser. No. 18/829,275, entitled “METHOD AND APPARATUS FOR CHROMATIC DISPERSION COMPENSATION” and filed on Sep. 9, 2024. Continuing with reference to FIG. 2, the optical signal networking system 206 includes a coherent optical transmitter 207 and a coherent optical receiver 209 coupled by at least one optical fiber 208. The receiver 209 includes a coherent receiver 210, a local oscillator laser 211 transmitting a local clock 211-1 to the coherent receiver 210, the coherent digital signal processor (DSP) 20, and serializer/deserializer 212. The coherent DSP 20 may include a signal processor 200. The optical receiver 209 facilitates communication of client data 213 from the transmitter 207. The coherent receiver 210 may transmit a received digital signal 201 to the coherent DSP 200, and the coherent DSP may compute a further phase-noise-compensated digital signal 210 from the receive digital signal 201 and transmit the further phase-noise-compensated digital signal to a serializer/deserializer 212.

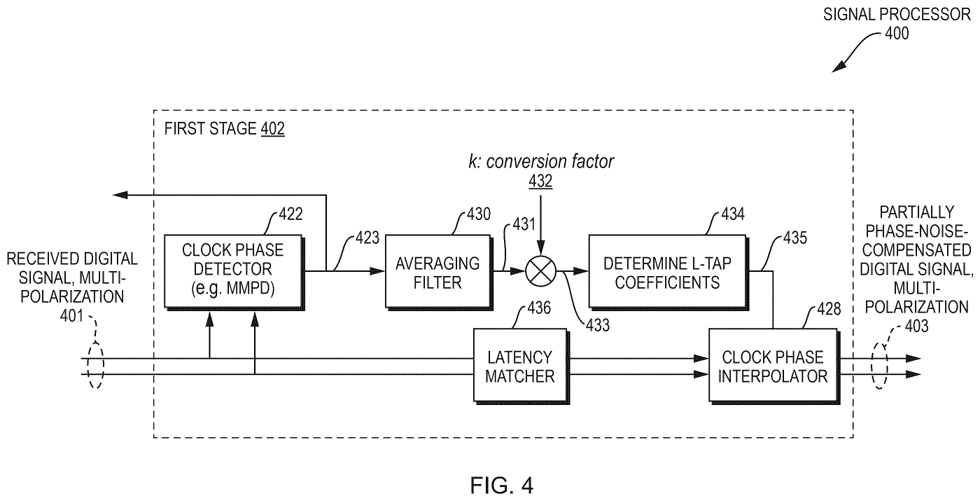

In some embodiments, when dispersion is smaller, for example at shorter distances, the amount of EEPN is not extreme. Some power may be saved by utilizing a path without the sub-band independent phase recovery block, for example, the first path 100B-2 of FIG. 1C. This may be determined at the start of system acquisition. During system acquisition, the receiver 209 would be configured to determine automatically the amount of dispersion embedded in the signal. The dispersion may be auto-discovered by the receiver 209 to program properly a chromatic dispersion equalizer (not shown) that is further described in reference to at least FIGS. 3, 4A, and 4B. The dispersion discovered may also be used to determine, based upon a threshold, a path of a phase noise compensator, for example, the first path 100B-2 or the second path 100B-3 in FIG. 1B. The dispersion threshold may be, for a non-limiting example, 50,000 ps/nm. The first path 100B-2 may be used for a signal with phase noise less than the threshold and the second path 100B-3 may be used for a signal with phase noise greater than the threshold.

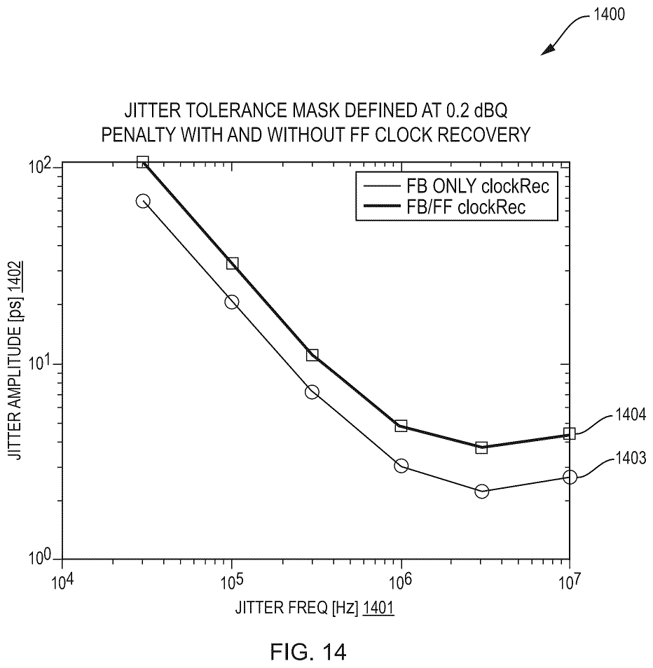

FIG. 3 is a block diagram of an example embodiment of a receiver 309 that may be employed as the receiver 209 of FIG. 2, disclosed above. Continuing with reference to FIG. 3, the receiver 309 includes an analog-to-digital converter (ADC) 314 that outputs discrete digital signals 315 to a chromatic dispersion equalizer (CDEQ) 316. The ADC may receive a clock signal from a voltage-controlled oscillator (VCO) 314-1 and the clock signal may be a source of the phase noise, e.g., phase jitter. The phase noise from the VCO 314-1 is further described reference to at least FIG. 14. The CDEQ 316 outputs chromatic dispersion equalized signals 317 to a feedback clock phase recovery (CPR) block 318. The ADC 314 may output a number of discrete digital signals 315, in which case the chromatic dispersion equalization signals 317 may be complex signals. The feedback CPR block 318 includes a polarization mode dispersion (PMD) equalizer/feedback clock phase interpolator block 319 that outputs PMD-equalized signals 320 to a carrier phase recovery block 321, the carrier phase recovery block 321 outputting received digital signals 301. The feedback CPR block 318 may include a clock phase detector 322 to compute a phase delay 323 from the received digital signals. A feedback clock recovery block 324 computes a digital value 325 that enables feedback clock phase recovery using the PMD equalizer (PMDEQ)/clock interpolator block 319, for example, in a phase-lock-loop technique.

A first stage 302 of a phase noise compensator 300-1 includes a feedforward CPR block. The first stage 302 may include the clock phase detector 322 that computes the phase delay 323 from the received digital signal 302. The clock phase detector 322 and the phase delay 323 may be used to drive both the feedback CPR block 318 and the first stage 302. The first stage 302 further includes a feedforward clock recovery block 326 that determines a plurality of coefficients 327 for a feedforward clock phase interpolator 328, e.g., a finite impulse response filter. The feedforward clock phase interpolator 344 generates a partially phase-noise-compensated digital signal 303 from the received digital signal 301 using the coefficients 327.

A second stage 304 of the phase noise compensator 300-1 includes a sub-band independent carrier phase recovery block. The second stage 304 computes a further phase-noise-compensated digital signal 305 from the partially phase-noise-compensated digital signal 303. The second stage may be configured to generate the further phase-noise-compensated digital signal 305 by computing a set of components of the partially phase-noise-compensated digital signal 303, determining, on a per-component basis, a respective phase distortion for components of the set of components computed, computing a set of corrected components by applying, on the per-component basis, the respective phase distortion determined, and generating a further phase-noise-compensated digital signal 305 based on the set of corrected components computed.

Additionally, the ADC block may output digital signals 314 based on a multi-polarization signal, in which case the digital signals may include signals of different polarizations, for example, an X polarization signal and a Y polarization signal. In the case of multiple polarizations, the chromatic dispersion equalized signals 316, PMD equalized signals 319, received digital signals 301, partially phase-noise-compensated digital signals 303, and further phase-noise-compensated digital signals 304 may include independent digital signals for the multiple polarizations. The CDEQ 316, PMD equalizer/feedback clock interpolator 319, carrier phase recovery block 321, feedforward clock phase interpolator 328, and second stage 304 may be configured to perform the same operation on the multiple polarizations independently. The feedback clock recovery block 324 and the feedforward clock recovery block 326 may be configured to use the phase delay 323 of the multiple polarizations by averaging across the phase delay of the respective multiple polarizations. It will be understood that the phase delay of a polarization of the multiple polarizations is expected to be similar to the phase delay of another polarization of the case of multiple polarizations, for example, in the case of EEPN phase distortion effects in a coherent optical communications.

FIG. 4 is a block diagram of an example embodiment of a first stage 402 of a signal processor 400 that may be similar to the first stage 302 of the receiver 309. Continuing with reference to FIG. 4, the received digital signal 401 may be a multi-polarization digital signal including a signal for each polarization, for example, X polarization and Y polarization in a two-polarization signal. The received digital signal 401 is transmitted to a clock phase detector 422 that computes a phase delay 423. The phase delay 423 of the polarizations, for example, X polarization and Y polarization, may be averaged. An averaging filter 430 averages the phase delay 423 over a number of clock cycles, for example, five clock cycles or ten clock cycles, in time to produce an averaged phase delay 431. An optional scaling factor 432 may be applied as a multiplier to the averaged phase delay 431 to generate a phase offset 433, e.g., a scaled phase delay. A filter coefficient determiner 434, for example, a look-up table, determines a set of filter coefficients 435 from the phase offset 433. A clock phase interpolator 428, for example, a filter with coefficients 435, generates a partially phase-noise-compensated digital signal 403 by applying the phase offset 433 to the received digital signal 401, the received digital 401 having passed through a latency matcher 436. For multi-polarization signals, the filtering is performed separately for each polarization.

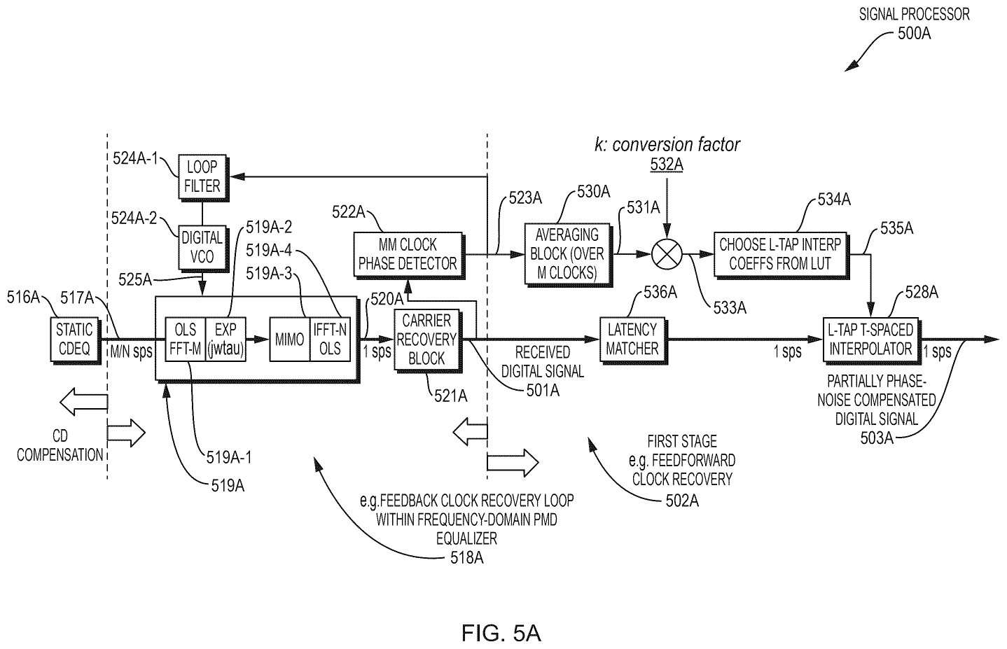

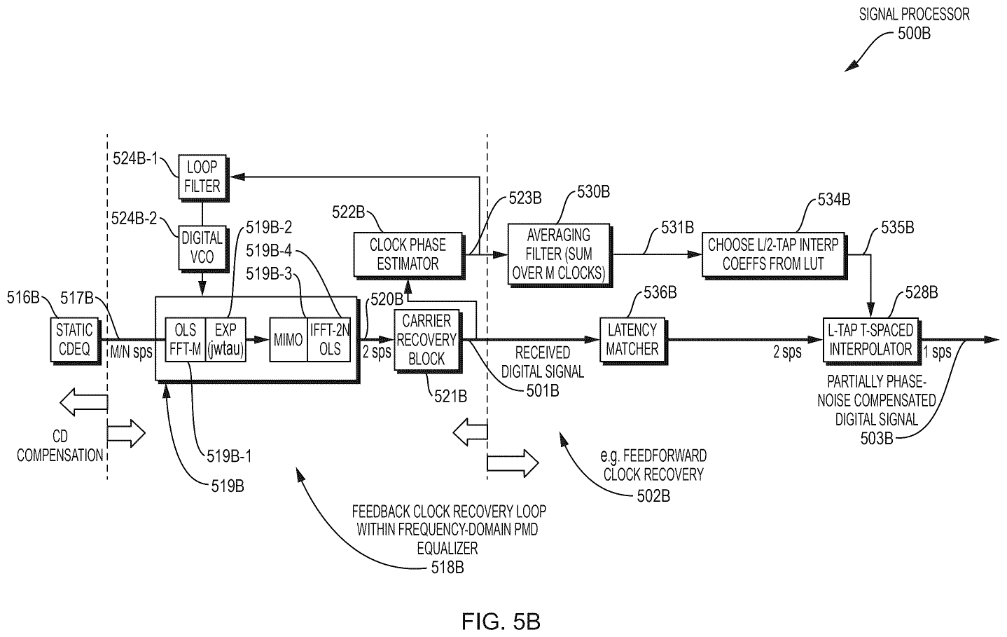

FIG. 5A is a block diagram of an example embodiment of a portion of a signal processor 500A including a feedback clock phase recovery block 518A and a first stage 502A. The first stage 502A may be similar to the first stage 402 of signal processor 400. Continuing with FIG. 5A, a CDEQ 516A transmits complex digital signals 517A to a PMDEQ/feedback clock phase interpolator block 519A. The complex digital signals 517A may be complex digital signals including multiple polarizations, e.g., X polarization and Y polarization. The PMDEQ/feedback clock phase interpolator block 519A outputs PMD-equalized digital signals 520A. The PMD-equalized digital signals 520A may be complex digital signals including multiple polarizations and may be output at different rates, e.g., 1 sample per symbol. A carrier phase recovery block 521A generates received digital signals 501A from the PMD-equalized digital signals 520A and compensates for laser noise sourced from a transmitter and a receiver, for example, a transmitter laser of the transmitter and a receiver laser of the receiver.

The feedback CPR block 518A further includes a clock phase detector 522A that estimates phase delays 523A for every clock cycle. The phase delays 523A may also be called a tau error or a signal delay error. The phase delays may be averaged for across polarizations for digital signals including multiple polarization, e.g., averaging the phase delay of an X polarization signal and a Y polarization signal. A loop filter block 524A-1 implements a phase lock loop, for example, a 2^{nd} order phase lock loop, and outputs a single value every clock cycle based on the phase delay 523A to a digital VCO 524A-2. The digital VCO 524A-2 converts the single output of the loop filter block into t values 525A for the PMDEQ/clock phase interpolator block 519A.

The PMDEQ/feedback clock phase interpolator block 519A further includes a component computation block 519A-1, for example, an FFT block that computes M components from M input samples. A phase delay multiplication block 519A-2 applies the τ values 525A to the M components by multiplying the M components by e^{-jωτ} where ω is a frequency and the τ values 525A s received from the digital VCO 524A-2. The phase delay multiplication block 519A-2 compensates for clock phase delay as part of the feedback loop of the feedback CPR block 518A. A multiple-input multiple-output (MIMO) equalizer block 519A-3 compensates for polarization and rotation and PMD. The MIMO equalizer block 519A-3 may be referred to as a PMDEQ and may include a set of multipliers, for example, XX, YX, XY, YY multipliers, that are applied to the signal. An inverse block 519A-4 of the component computation block 519A-1 produces the PMD equalized signal 520A. The inverse block 519A-4 may have a size N and the rate of the PMD equalized signal 520A may be 1 samples per symbol, the rate determined by the size N of the inverse block 519A-4 and the size M of the component computation block 519A-1.

In the first stage 502A, e.g., a feedforward CPR stage, an averaging block 530A computes an average of the phase delays 523A over several clock cycles to generate averaged phased delays 531A. An optional scaling, or conversion, factor 532A may be applied to the averaged phased delays to generate a phase offset 533A, e.g., a scaled phase delay. A filter coefficient determiner 534A converts the phase offset 533A to a set of coefficients 535A for the clock phase interpolator 528A. The clock phase interpolator applies a delay to the received digital signal 501A, the received digital signal having passed through a latency matcher 536A, based on the set of coefficients 535A to generate a partially phase-noise-compensated digital signal 503A.

FIG. 5B is a block diagram of another example embodiment of a portion of a signal processor 500B that may be similar to signal processor 500A, the signal processor 500B also including a feedback clock phase recovery block 518B and a first stage 502B. Continuing with FIG. 5B, a CDEQ 516B transmits complex digital signals 517B to a PMDEQ/feedback clock phase interpolator block 519B. The complex digital signals 517B may be complex digital signals including multiple polarizations, e.g., X polarization and Y polarization. The PMDEQ/feedback clock phase interpolator block 519B outputs PMD-equalized digital signals 520B. The PMD-equalized digital signals 520B may be complex digital signals including multiple polarizations and may be output at different rates, e.g., 2 samples per symbol. A carrier phase recovery block 521B generates received digital signals 501B from the PMD-equalized digital signals 520B and compensates for laser noise sourced from a transmitter and a receiver, for example, a transmitter laser of the transmitter and a receiver laser of the receiver.

The feedback CPR block 518B further includes a clock phase detector 522B that estimates phase delays 523B for every clock cycle. The phase delays 523B may also be called a tau error or a signal delay error. The phase delays may be averaged for across polarizations for digital signals including multiple polarization, e.g., averaging the phase delay of an X polarization signal and a Y polarization signal. A loop filter block 524B-1 implements a phase lock loop, for example, a 2^{nd} order phase lock loop, and outputs a single value every clock cycle based on the phase delay 523B to a digital VCO 524B-2. The digital VCO 524B-2 converts the single output of the loop filter block into t values 525A for the PMDEQ/clock phase interpolator block 519B.

The PMDEQ/feedback clock phase interpolator block 519B further includes a component computation block 519B-1, for example, an FFT block that computes M components from M input samples. A phase delay multiplication block 519B-2 applies the τ values 525B to the M components by multiplying the M components by e^{-jωτ} where ω is a frequency and the τ values 525B received from the digital VCO 524B-2. The phase delay multiplication block 519B-2 compensates for clock phase delay as part of the feedback loop of the feedback CPR block 518B. A multiple-input multiple-output (MIMO) equalizer block 519B-3 compensates for polarization and rotation and PMD. The MIMO equalizer block 519B-3 may be referred to as a PMDEQ and may include a set of multipliers, for example, XX, YX, XY, YY multipliers, that are applied to the signal. An inverse block 519B-4 of the component computation block 519B-1 produces the PMD equalized signal 520B. The inverse block 519B-4 may have a size 2N, as opposed to the inverse block 519A-4 with size N, and the rate of the PMD equalized signal 520B may be 2 samples per symbol, the rate determined by the size 2N of the inverse block 519B-4 and the size M of the component computation block 519B-1.

In the first stage 502B, e.g., a feedforward CPR stage, an averaging block 530B computes an average of the phase delays 523B over several clock cycles to generate averaged phased delays 531B. Unlike for the signal processor 500A, no scaling factor is applied to the averaged phase delays 531B. A filter coefficient determiner 534B converts the phase delays 531B to a set of coefficients 535B for the clock phase interpolator 528B. The clock phase interpolator applies a delay to the received digital signal 501B, the received digital signal having passed through a latency matcher 536B, based on the set of coefficients 535B to generate a partially phase-noise-compensated digital signal 503B. The partially-phase-noise-compensated digital signal is converted to a 1 sample per symbol signal by the clock phase interpolator 528B.

In some example embodiments, the clock phase interpolator 428, 528A, 528B is a finite impulse response filter associated with the set of coefficients 435, 535A, 535B. The number of coefficients in the set of coefficients may vary, for example, 3, 5, 7, 21, or 51.

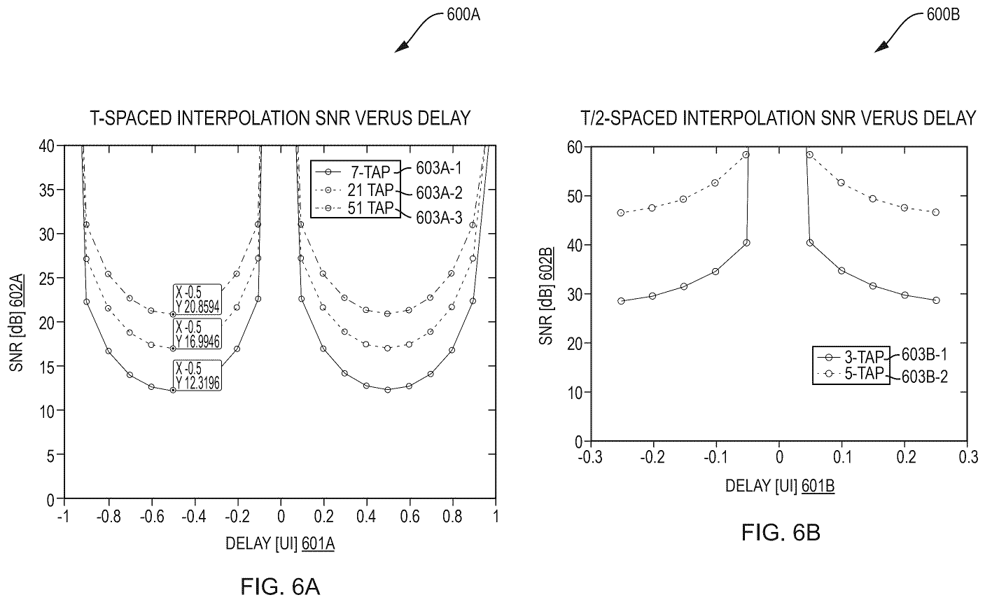

FIG. 6A is a plot 600A of an example embodiment of results from a simulation of a signal-to-noise performance. The plot 600A illustrates the signal-to-noise ratio (SNR) 602A in decibels (dB) at different phase delays 601A in unit intervals (UI) for a finite impulse response filter with 7 coefficients (7-tap 603A-1), 21 coefficients (21-tap 603A-2), and 51 coefficients (51-tap 603A-3) applied to a signal, e.g., received digital signal 301, 501A, 501B, sampled at a rate of 1 sps.

FIG. 6B is a plot 600B of an example embodiment of results from another simulation of signal-to-noise performance. The plot plot 600B illustrating the SNR 602B at different phase delays 601B for a finite impulse response filter with 3 coefficients (3-tap 603B-1) and 5 coefficients (5-tap 603B-2), applied to a signal, e.g., the received digital signal 401, sampled at 2 sps. In general, FIG. 6A-6B illustrate results from simulations of the signal-to-noise performance of different filter configurations of clock phase interpolators, e.g., clock interpolators 428, 528A, 528B.

FIGS. 7-1 and 7-2 are a block diagram of an example embodiment of a second stage 704 of a phase noise compensator configured to compensate for phase noise on a per-component basis. The second stage 704 may be similar to the second stage 304 of signal processor 300. Continuing with reference to FIGS. 7-1 and 7-2, a fast Fourier transform (FFT) block 743-1 breaks a partially phase-noise-compensated digital signal 703, the partially phase-noise-compensated digital signal including signals for an X polarization and a Y polarization each of length i (x[i], y[i]), into an N number of components per polarization (X[n], Y[n]), where a length of i is equal to a length of N. A grouping block 744-1 forms K sub-bands 745 from the N components, each sub-band of the K sub-bands including M components, or bins (X[n], Y[n], n=0: M−1; X[n], Y[n], n=M:2*M−1 . . . X[n], Y[n], n=N−M:N). A phase demodulator 740 includes a slicer 741 that determines a set of decided symbols from the partially phase-noise-compensated digital signal 703 and generates an additional digital signal 742 (\hat{x}[i], ŷ[i]) based on the set of decided symbols. An additional FFT block 743-2 breaks the additional digital signal 742 into N components (\hat{X}[n], Ŷ[n]) and a grouping block 744-3 groups the N components into an additional K sub-bands 749 (\hat{X}[n], Ŷ[n] n=0: M−1; \hat{X}[n], Ŷ[n], n=M:2*M−1 . . . \hat{X}[n], Ŷ[n], n=N-M:N). A plurality of conjugation blocks 750, including per-sub-band conjugation blocks 750-1 . . . 750-K, determine the complex conjugate of the additional K sub-bands 749 to produce K complex conjugate sub-bands 751 (\hat{X}*[n], Ŷ*[n] n=0:M−1; \hat{X}*[n], Ŷ*[n], n=M:2*M−1 . . . \hat{X}*[n], Ŷ*[n], n=N−M:N).

The K sub-bands 745 and the K complex conjugate sub-bands 751 are used to remove the modulation on a sub-band basis in a plurality of phase distortion computation blocks 752, including phase distortion blocks 752-1 . . . 752-K. A block of the plurality of phase distortion computation blocks 752 multiples, on a per-sub-band basis, in multiplication block 754 the components within the K sub-bands 745 and the K complex conjugate sub-bands 751 to generate M phase distortions 755 per sub-band, one phase distortion per component within the sub-band. A summing block 756 sums over the M components of a sub-band to generate a frequency summed phase distortion 757 for each sub-band. For multi-polarization signals, the sub-bands for the X polarization and Y polarization are summed together, and the equation for the summing block 756 may be expressed as:

$${\sum }_{n = 0}^{M} X [ n ] \cdot {\hat{X}}^{*} [ n ] + Y [ n ] \cdot {\hat{Y}}^{*} [ n ]$$

A second summing block 758 sums the frequency summed phase distortions 757 over a number L of clock cycles, for example, 1, 5, or 10 clock cycles, to generate a temporally summed phase distortion 759 for each sub-band. A phase computation block 760 computes an angle function based on the temporally summed phase distortion 759, which is converted into a phase correction 762 per-sub-band (e^{-j·φ}^{₀}, . . . , e^{-j·φ}^{_{K−1}}). The K sub-bands 745 pass through a latency matcher 746 to generate K latency-matched sub-bands 747. The phase multiplier 762 for each sub-band is then applied to each component of each sub-band in a plurality of multiplication blocks 764-1 . . . 764-K to generate K corrected sub-bands 765 (X[n]·e^{-jφ}^{₀}, Y[n]·e^{-j·φ}^{₀}, n=0:7; X[n]·e^{-j·φ}^{_{K−1}}, Y[n]·e^{-j·φ}^{_{K−1}}, n=N−M:N−1). The N components of the K corrected sub-bands 765 are reconstructed into a further phase-noise-compensated digital signal 705 by an inverse fast Fourier transform (IFFT) block 766.

Optionally, the second stage 704 may include an additional scaling block 770 for the angle function 760 to compute a scaled version of the phase correction 762 per sub-band. The partially phase-noise-compensated digital signal 703 and the additional digital signal 742 are transmitted to an error calculation block 768, which calculates an error 769, for example, a mean squared error. The error 769 can be used in the scaling block 770 to scale the computed phase correction 762.

FIGS. 8-1, 8-2, and 8-3 are a block diagram of another example embodiment of a second stage 804 of a phase noise compensator configured to compensate for phase noise on a per-component basis. The second stage 804 may be similar to the second stage 704, but includes a subsequent block of phase-noise-compensation after a first block 804A. The first block 804A of the second stage 804 may be similar to the second stage 704. Similar features are designated using like reference numbers but increased by 100 and with the reference marker A. The second stage 804 generates a still further phase-noise-compensated signal 805 from a partially phase-noise-compensated digital signal 803.

Continuing with reference to FIGS. 8-1, 8-2, and 8-3, in the first block 804A of the second stage 804, a fast Fourier transform (FFT) block 843A-1 breaks a partially phase-noise-compensated digital signal 803, the partially phase-noise-compensated digital signal including signals for an X polarization and a Y polarization each of length i (x[i], y[i]), into an N number of components per polarization (X[n], Y[n]), where a length of i is equal to a length of N. A grouping block 844-1 forms K sub-bands 845A from the N components, each sub-band of the K sub-bands including M components, or bins (X[n], Y[n], n=0:M−1; X[n], Y[n], n=M:2*M−1 . . . X[n], Y[n], n=N−M:N). A phase demodulator 840A includes a slicer 841A that determines a set of decided symbols from the partially phase-noise-compensated digital signal 803 and generates an additional digital signal 842A (\hat{x}[i], ŷ[i]) based on the set of decided symbols. An additional FFT block 843A-2 breaks the additional digital signal 842A into N components (\hat{X}[n], Ŷ[n]) and a grouping block 844A-3 groups the N components into an additional K sub-bands 749A (\hat{X}[n], Ŷ[n] n=0:M−1; \hat{X}[n], Ŷ[n], n=M:2*M−1 . . . \hat{X}[n], Ŷ[n], n=N−M:N). A plurality of conjugation blocks 850A, including per-sub-band conjugation blocks 850A-1 . . . 850A-K, determine the complex conjugate of the additional K sub-bands 849 to produce K complex conjugate sub-bands 851A (\hat{X}*[n], Ŷ*[n] n=0:M−1; \hat{X}*[n], Ŷ*[n], n=M:2*M−1 . . . \hat{X}*[n], Ŷ*[n], n=N−M:N).

The K sub-bands 845A and the K complex conjugate sub-bands 851A are used to remove the modulation on a sub-band basis in a plurality of phase distortion computation blocks 852A, including phase distortion blocks 852A-1 . . . 852A-K. A block of the plurality of phase distortion computation blocks 852A performs, on a per-sub-band basis, a multiplication 854A of components within the K sub-bands 845A and the K complex conjugate sub-bands 851A to generate M phase distortions 855A per sub-band, one phase distortion per component within the sub-band. A summing block 856A sums over the M components of a sub-band to generate a frequency summed phase distortion 857A for each sub-band. For multi-polarization signals, the sub-bands for the X polarization and Y polarization are summed together.

A second summing block 858A sums the frequency summed phase distortions 857A over a number/of clock cycles, for example, 1, 5, or 10 clock cycles, to generate a temporally summed phase distortion 859A for each sub-band. A phase computation block 860A computes an angle function based on the temporally summed phase distortion 859A, which is converted into a phase correction 862A per-sub-band (e^{-j·φ}^{₀}, . . . , e^{-j·φ}^{_{K−1}}). The K sub-bands 845A pass through a latency matcher 846A to generate K latency-matched sub-bands 847A. The phase multiplier 862A for each sub-band is then applied to each component of each sub-band in a plurality of multiplication blocks 864A-1 . . . 864A-K to generate K corrected sub-bands 865A (X[n]·e^{-j·φ}^{₀}, Y[n]·e^{-j·φ}^{₀}, n=0:7; X[n]·e^{-j·φ}^{_{K−1}}, Y[n]·e^{-j·φ}^{_{K−1}}, n=N−M:N−1). The N components of the K corrected sub-bands 865 are reconstructed into a further phase-noise-compensated digital signal 867 by an inverse fast Fourier transform (IFFT) block 866A.

The subsequent block of the second stage 804 performs a similar phase noise compensation on the per-sub-band basis. The further phase-noise-compensated digital signal 867 output from the first block 804A is transmitted to the second block. The second block is similar to the first block 804A and similar features are designated using like reference numbers and the reference marker B. The subsequent block includes a phase modulator 840B with a slicer 841B, the slicer 841B estimating a set of decided symbols from the further phase-noise-compensated digital signal 867 and generating an additional digital signal 842B based on the set of decided symbols. An FFT block 843B breaks the additional digital signal 842B into N frequency components and a grouping block 844B groups the N components into K sub-bands 849B, a sub-band of the K sub-bands having M components. A plurality of conjugation blocks 850B, including individual blocks 850B-1 . . . 850B-K, generate K complex conjugate sub-bands 851B from the K sub-bands. A plurality of phase distortion compensation blocks 852B, including phase distortion compensation blocks 852B-1 . . . 852B-K, multiples, on a per-sub-band basis, in a multiplication block 854B components within the K complex conjugate sub-bands 851B and K latency matched sub-bands 847B, the K latency matched sub-bands 847B generated by a latency matcher 846B from a set-of-sub-bands 845A of the partially phase-noise-compensated digital signal. The multiplication block 854B generates M phase distortions 855B per sub-band, one phase distortion for each component within a sub-band. A summing block 856B sums over the M phase distortions 855B and any signal polarizations to generate a frequency summed phase distortion 857B. A second summing block 858B sums the frequency summed phase distortion 857B over a number of clock cycles, e.g., 5 or 10, to generate a temporally summed phase distortion 859B. A phase computation block 860B computes an angle function based on the temporally summed phase distortion 859B to generate a phase correction 862B per sub-band. A plurality of multiplication blocks 864B-1 . . . 864B-K applies, on the per-sub-band basis, the phase correction 852B of each sub-band to the components within the sub-band to generate K corrected sub-bands 865B. An IFFT block 866B reconstructs the still further phase-noise-compensated digital signal 805 based on the K corrected sub-bands.

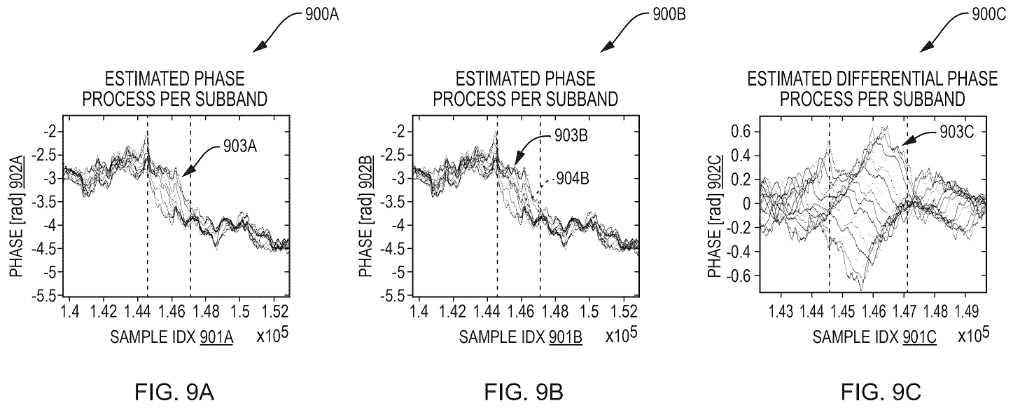

FIG. 9A is a plot 900A of an example embodiment of results from simulations of phase component of a digital signal on a sub-band-by-sub-band basis. The plot 900A depicts the phase 902A versus samples 901A, and thereby time, of phases of sub-bands 903A of the digital signal.

FIG. 9B is a plot 900B of the results of FIG. 9A along with a common mode phase estimate 904B of a digital signal. The plot 900B similarly depicts the phase 902B versus samples 901B of phases of sub-bands 903B of the digital signal. The common mode phase estimate 904B would be the output from the classic carrier phase recovery running on the entire single carrier signal spectrum.

FIG. 9C is a plot 900C of an example embodiment of phase distortion 903C of a digital signal computed as a difference between phase components of the digital signal of FIG. 9A and the common mode phase estimate of FIG. 9B. The plot 900C depicts the phase 903C versus samples 903B of the phase distortion 903C.

In general, the simulations of FIG. 9A-B are performed for a simulated system with a 124 Giga Baud (Gbd) symbol rate, a dispersion of 50,000 ps/nm, and a laser linewidth of 300 kHz on both the transmitter and the receiver lasers. Components are computed from the received digital signal processed using a classic carrier phase recovery and grouped into 16 sub-bands.

FIG. 9B is a plot 900B of phase 902B versus samples 901B of the phase of the signal on a per-sub-band

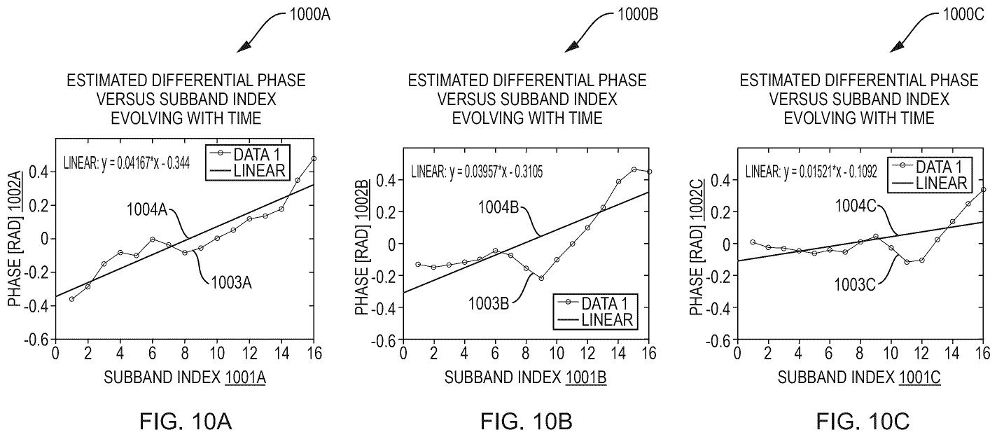

FIG. 10A is a plot of an example embodiment of results from a simulation of differential phase distortion with respect to a sub-band index.

FIG. 10B is a plot of an example embodiment of the results from the plot of FIG. 10A at a different point in time.

FIG. 10C is another plot of an example embodiment of the results from FIG. 10A at another point in time.

In general, FIGS. 10A-10C are plots 1000A, 1000B, 1000C of phase 1002A, 1002B, 100C versus sub-band index 1001A, 1001B, 1000C for estimated differential phase distortion 1003A, 1003B, 1003C at three different points in time. Best fit lines 1004A, 1004B, 1004C are also shown.

At any given instant in time, the phase noise versus sub-band index, i.e., versus frequency, indicates the residual phase distortion on the signal which translates into inter-symbol interference (ISI) and performance degradation. The phase distortion on the per-sub-band basis 1003A, 1003B, 1003C is typically a non-linear function. The linear part of the phase noise is translated as a jitter (or time delay) that is compensated by a feedback clock recovery block, e.g. stage 318, 518A, 518B, and a feedforward clock recovery block, e.g. first stage 302, 402, 502A, 502B. The remaining higher order nonlinear portion of the phase distortion is compensated for by the second stage 104, 304, 704, 804, e.g. a sub-band independent phase recovery block. The second stage may be capable of providing additional EEPN mitigation and performance enhancement versus a clock recovery approach.

The second stage, e.g., the sub-band independent carrier phase recovery block, compensates for phase noise on the per-sub-band basis and may be capable of providing additional mitigation of non-linear EEPN noise and improved performance.

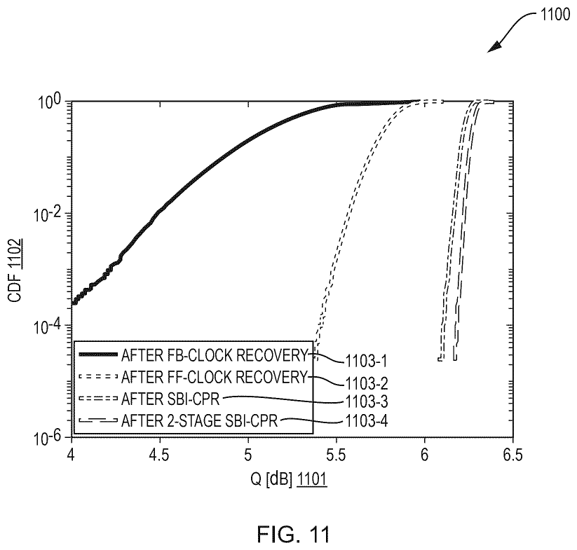

FIG. 11 is a plot 1100 of an example embodiment of results from simulations of a cumulative density function of Q penalty. The plot 1100 shows the cumulative density functions 1102 of a Q penalty metric 1101 for signal processors with only a feedback CPR block 1103-1, with the feedback CPR block and the first stage only 1103-2, with the feedback CPR block and the first stage and a single-block second stage 1103-3, and the feedback CPR block, the first stage, and a second stage with a first and a subsequent block 1103-3.

A clock phase interpolator 428, 528A, 528B of a first stage 402, 502A, 502B may include, as shown in FIG. 6, a number of coefficients associated with a filter, for example a finite impulse response filter, to apply a phase delay 433A, 553A, 531B to a received digital signal 401, 501A, 501B.

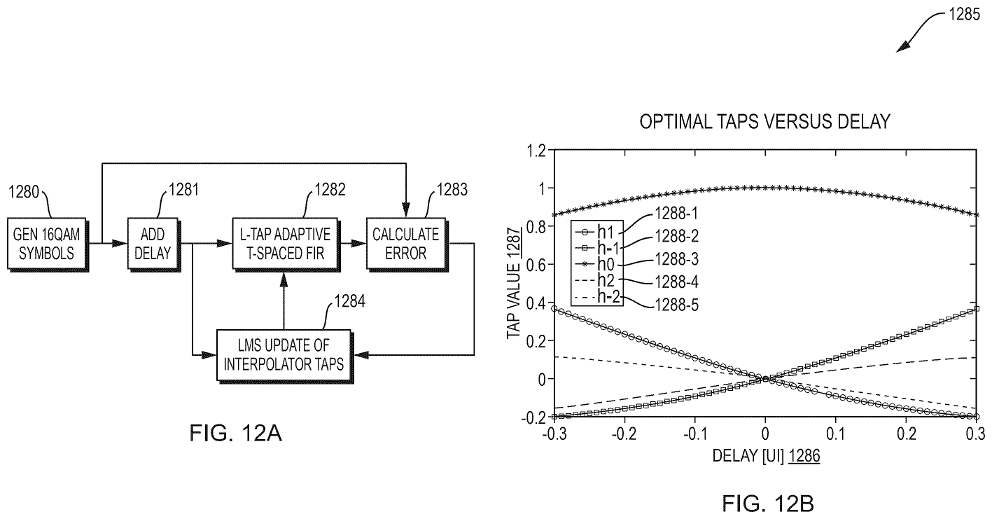

FIG. 12A is a block diagram of an example embodiment of a workflow for acquiring optimum filter coefficients for an L-tap adaptive T-spaced finite impulse response filter in simulation. The workflow comprises generating a digital signal 1280, introducing a delay to the digital signal 1281, applying a filter to the delayed digital signal 1282, computing an error between the filtered digital signal and the generated digital signal 1283, and updating the filter coefficients based on the error computed and the known delay introduced 1284.

FIG. 12B is a plot 1285 of an example embodiment of results from the plot of FIG. 12A that discloses optimal filter coefficients for a 5-tap filter as a function of phase delay. The plot 1285 of tap, or coefficient, value 1287 versus delay 1286 of a 5-coefficient finite impulse response filter, with tap indices of h1 1288-1, h-1 1288-2, h0 1288-3, h2 1288-4, and h-2 1288-5

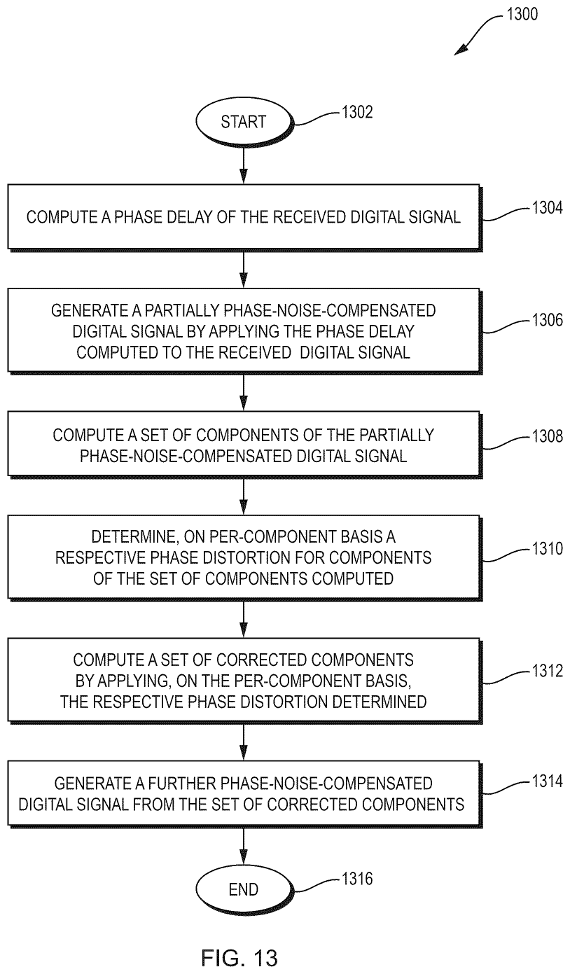

FIG. 13 is a flow diagram of an example embodiment of a method 1300 for compensating for phase noise in a received digital signal. The method begins (1302) and comprises computing a phase delay of the received digital signal (1304) and generating a partially phase-noise-compensated digital signal by applying the phase delay computed to the received digital signal (1306). The method further comprises computing a set of components of the partially phase-noise-compensated digital signal (1308), determining, on a per-component basis, a respective phase distortion for components of the set of components computed (1310), computing a set of corrected components by applying, on the per-component basis, the respective phase distortion determined (1312), and generating a further phase-noise-compensated digital signal from the set of corrected components computed (1314). The method thereafter ends (1316) in the example embodiment.

FIG. 14 is a plot 1400 of an example embodiment of results from simulations of phase noise jitter amplitude 1402 versus jitter frequency 1401. In addition to EEPN, an additional source of noise may arise from jitter, or timing uncertainties, inherent to the voltage-controlled oscillators (VCOs), for example, an oscillator used to generate a clock for a transmitter 207 and a local oscillator 222 used to generate a local clock for a receiver 210 in FIG. 2. It will be understood that all VCO have phase noise as they are oscillators and that they are a source of signal degradation in an optical system. Having a feedforward clock phase recovery block, e.g., first stage 102, 302, 402, 502A, 502B, results in higher tolerance to jitter. Jitter tolereance is better across all frequencies simulated for a simulated system with feedback and feedforward CPR blocks 1403 as opposed to with feedback only 1404.

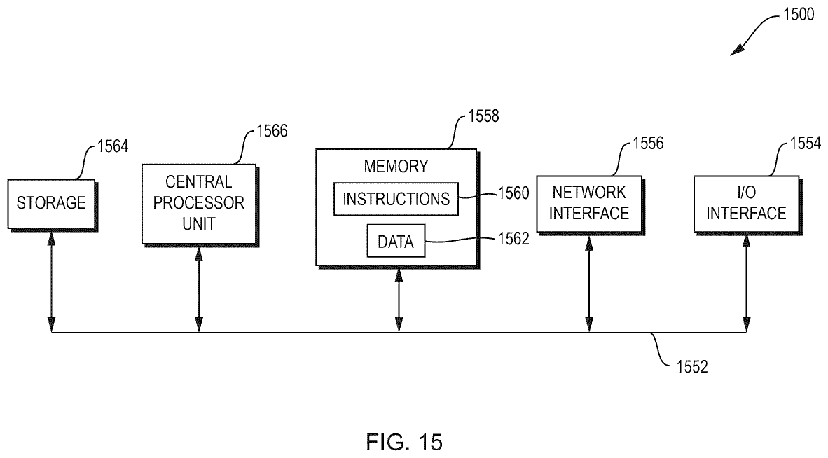

FIG. 15 is a block diagram of an example of the internal structure of a computer 1500 in which various embodiments of the present disclosure may be implemented. The computer 1500 contains a system bus 1552, where a bus is a set of hardware lines used for data transfer among the components of a computer or digital processing system. The system bus 1552 is essentially a shared conduit that connects different elements of a computer system (e.g., processor, disk storage, memory, input/output ports, network ports, etc.) that enables the transfer of information between the elements. Coupled to the system bus 1552 is an I/O device interface 1554 for connecting various input and output devices (e.g., keyboard, mouse, displays, printers, speakers, etc.) to the computer 1500. A network interface 1556 allows the computer 1500 to connect to various other devices attached to a network (e.g., global computer network, wide area network, local area network, etc.). Memory 1558 provides volatile or non-volatile storage for computer software instructions 1560 and data 1562 that may be used to implement embodiments (e.g., method 1300) of the present disclosure, where the volatile and non-volatile memories are examples of non-transitory media. Disk storage 1564 provides non-volatile storage for computer software instructions 1560 and data 1562 that may be used to implement embodiments (e.g., method 1300) of the present disclosure. A central processor unit 1566 is also coupled to the system bus 1552 and provides for the execution of computer instructions.

An example embodiment disclosed herein may employ hardware, software, firmware, electronic control component, processing logic, and/or processor device, individually or in any combination, including without limitation: an application specific integrated circuit (ASIC), a field-programmable gate-array (FPGA), an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods described herein. It should be understood that elements of the block and flow diagrams may be implemented in software or hardware, such as via one or more arrangements of circuitry of FIG. 15, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A signal processor configured to compensate for phase noise in a received digital signal, the signal processor comprising:
a first stage of a phase noise compensator configured to compute a phase delay of the received digital signal and generate a partially phase-noise-compensated digital signal by applying to the received digital signal the phase delay computed; and
a second stage of the phase noise compensator coupled to the first stage, the second stage configured to (i) compute a set of components of the partially phase-noise-compensated digital signal, (ii) determine, on a per-component basis, a respective phase distortion for components of the set of components computed, (iii) compute a set of corrected components by applying, on the per-component basis, the respective phase distortion determined, and (iv) generate a further phase-noise-compensated digital signal based on the set of corrected components computed.

2. The signal processor of claim 1, wherein the first stage includes a clock phase detector and wherein the clock phase detector is configured to compute the phase delay of the received digital signal.

3. The signal processor of claim 1, wherein the first stage is further configured to derive a phase offset from the phase delay computed and to generate the phase-noise-compensated signal by applying the phase offset derived to the received digital signal.

4. The signal processor of claim 1, wherein the first stage includes a clock phase interpolator and wherein the clock phase interpolator is configured to generate the partially phase-noise-compensated digital signal.

5. The signal processor of claim 3, wherein the clock phase interpolator includes a filter associated with a plurality of coefficients and wherein the first stage is further configured to compute a coefficient of the plurality of coefficients based on the phase delay computed.

6. The signal processor of claim 1, wherein the second stage includes a slicer and wherein the slicer is configured to:
use a modulation technique to estimate a set of symbols from the partially phase-noise-compensated digital signal generated; and
generate, based on an inverse of the modulation technique used, an additional digital signal from the set of symbols estimated, wherein the second stage is further configured to:
compute an additional set of components of the additional digital signal generated; and
compare the set of components computed with the additional set of components computed to determine, on the per-component basis, the respective phase distortion.

7. The signal processor of claim 1, wherein the second stage is further configured to compute the set of components using a frequency-based decomposition method and to generate the further phase-noise-compensated digital signal using an inverse of the frequency-based decomposition method.

8. The signal processor of claim 1, wherein the set of components computed form a set of sub-bands, wherein a sub-band of the set of sub-bands includes at least one component of the set of components computed, the second stage further configured to:
determine, on a per-sub-band basis, a sub-band phase distortion based on the phase distortion of the at least one component included therein; and
compute the set of corrected components by applying, on the per-component basis, the phase distortion of the sub-band including the component.

9. The signal processor of claim 1, wherein the second stage is further configured to determine, on the per-component basis, the respective phase distortion by removing modulation and amplifier noise from the partially phase-noise-compensated digital signal.

10. The signal processor of claim 1, wherein the received digital signal is a digital representation of a continuous-time signal that has been sampled at a rate of at least one sample per symbol, and wherein the first stage is further configured to compute the phase delay based on a length of the received digital signal, the length based on the rate.

11. The signal processor of claim 1, wherein the phase noise is equalization enhanced phase noise, wherein the first stage is configured to compensate for the equalization enhanced phase noise in part, and wherein the second stage is configured to compensate further for the equalization enhanced phase noise.

12. A signal processor configured to compensate for phase noise in a received digital signal, the signal processor comprising:
a first path of a phase noise compensator configured to compute a phase delay of the received digital signal and generate a phase-noise-compensated digital signal by applying to the received digital signal the phase delay computed; and
a second path of the phase noise compensator, the second path including:
a first stage of the second path configured to compute the phase delay of the received digital signal and generate a partially phase-noise-compensated digital signal by applying to the received digital signal the phase delay computed; and
a second stage of the second path coupled to the first stage, the second stage configured to (i) compute a set of components of the partially phase-noise-compensated digital signal, (ii) determine, on a per-component basis, a respective phase distortion for components of the set of components computed, (iii) compute a set of corrected components by applying, on the per-component basis, the respective phase distortion determined, and (iv) generate a further phase-noise-compensated digital signal based on the set of corrected components computed;
the signal processor further configured to compensate for the phase noise using the first path or the second path based upon a threshold of the phase noise in the received digital signal.

13. A method for compensating for phase noise in a received digital signal, the method comprising:
computing a phase delay of the received digital signal;
generating a partially phase-noise-compensated digital signal by applying to the received digital signal the phase delay computed;
computing a set of components of the partially phase-noise-compensated digital signal;
determining, on a per-component basis, a respective phase distortion for components of components of the set of components computed;
computing a set of corrected components by applying, on the per-component basis, the respective phase distortion determined; and
generating a further phase-noise-compensated digital signal based on the set of corrected components computed.

14. The method of claim 13, further comprising deriving a phase offset from the phase delay computed and generating the phase-noise-compensated signal by applying the phase offset derived to the received digital signal.

15. The method of claim 13, wherein applying the phase delay computed further includes computing a coefficient of a plurality of coefficients based on the phase delay computed, the plurality of coefficients associated with a filter, the filter applying the phase delay computed to the received digital signal.

16. The method of claim 13, further comprising:
using a modulation technique to estimate a set of symbols from the partially phase-noise-compensated digital signal generated;
generating, based on an inverse of the modulation technique, an additional digital signal from the set of symbols estimated;
computing an additional set of components of the additional digital signal generated; and
comparing the set of components computed with the additional set of components computed to determine, on the per-component basis, the respective phase distortion.

17. The method of claim 13, wherein computing the set of components includes applying a frequency-based decomposition method and wherein generating a further phase-noise-compensated digital signal includes applying an inverse of the frequency-based decomposition method.

18. The method of claim 13, further comprising:
forming a set of sub-bands, wherein a sub-band of the set of sub-bands formed includes at least one component of the set of components computed;
determining, on a per-sub-band basis, a sub-band phase distortion based on the phase distortion of the at least one component included therein; and
computing the set of corrected components by applying, on the per-component basis, the sub-band phase distortion of the sub-bands including the component.

19. The method of claim 13, wherein determining, on the per-component basis, the respective phase distortion includes removing modulation and amplifier noise from the partially phase-noise-compensated digital signal.

20. A non-transitory computer-readable medium for compensating for phase noise in a received digital signal, the non-transitory computer-readable medium having encoded thereon a sequence of instructions which, when loaded and executed by at least one processor, causes the at least one processor to:
compute a phase delay of the received digital signal;
generate a partially phase-noise-compensated digital signal by applying to the received digital signal the phase delay computed;
compute a set of components of the partially phase-noise-compensated digital signal;
determine, on a per-component basis, a respective phase distortion for components of components of the set of components computed;
compute a set of corrected components by applying, on the per-component basis, the respective phase distortion determined; and
generate a further phase-noise-compensated digital signal based on the set of corrected components computed.
